(19) United States
(12) Patent Application Publication
(10) Pub. No.: US 2014/0097180 A1
(43) Pub. Date: Apr. 10, 2014

(54) METAL SHELL AND PLATE MEMBER WELDING METHOD

(71) Applicant: POWER MATE TECHNOLOGY CO., LTD, TAICHUNG (TW)

(72) Inventors: Lien-Hsing CHEN, TAICHUNG CITY (TW); HUI-HUNG HSIANG, SHALU TOWNSHIP (TW)

(73) Assignee: POWER MATE TECHNOLOGY CO., LTD, TAICHUNG (TW)

(21) Appl. No.: 13/708,619

(22) Filed: Dec. 7, 2012

(30) Foreign Application Priority Data
Oct. 8, 2012 (TW) 101137155

(51) Int. Cl. B23K 1/002

(52) U.S. Cl. CPC B23K 1/002
USPC 219/604

(57) ABSTRACT

A metal shell and plate member welding method includes the steps of: A) preparing a shell and a plate member, B) applying a solder material to the plate member, C) attaching the shell to the solder material at the plate member to form a semi-finished product and then putting the semi-finished product in a fence of a bottom tool member, D) moving the bottom tool member to insert the semi-finished product and the fence into the space surrounded by an induction coil of an induction heater and then pressing a top tool member on the semi-finished product, E) operating the induction coil to heat the border edge of the shell to a temperature level about 20° C.˜100° C. over the melting point of the solder material, thereby melting the solder material, and F) cooling down the solder material to finish the welding procedure.

### BACKGROUND OF THE INVENTION

1. Field of the Invention

The present invention relates to welding technology and more particularly, to a metal shell and plate member welding method.

2. Description of the Related Art

Taiwan Patent 460344, which is issued to the present inventor, discloses a method for bonding a shell and a plate member. This method uses an induction heater with an induction coil to heat a semi-finished product of a shell and a plate member. During the bonding process, the control of the heating temperature affects the quality of the finished product. If the heating temperature is not well controlled during the bonding process, the solder material may be not well melted due to that the heating temperature is too low, leading to a defective bonding result and poor quality of bonding between the shell and the plate member. If the heating temperature is too high, the plate member may be caused to blast. Therefore, control means is necessary to control the heating temperature, ensuring stability of welding quality.

Further, the aforesaid prior art method does not teach positioning between the shell and the plate member during the welding process. Keeping the plate member and the shell positively in position during the welding process enables the welding process to be performed stably and accurately, significantly reducing the probability of defective products.

### SUMMARY OF THE INVENTION

The present invention has been accomplished under the circumstances in view. It is the main object of the present invention to provide a metal shell and plate member welding method, which can control the heating temperature, avoiding defective products caused by temperature factors. It is another object of the present invention to provide a metal shell and plate member welding method, which keeps the shell and the plate member positively in position during welding, enabling the welding process to be performed steadily and accurately.

To achieve these and other objects of the present invention, a metal shell and plate member welding method comprises the steps of: A) preparing a metal shell having a border edge and a plate member, B) applying a solder material to a surface area of the plate member corresponding to the border edge of the shell to form a strip of solder material subject to a predetermined thickness and width, C) covering the shell on the plate member to attach the border edge of the shell to the solder material and to form a semi-finished product, and then putting the semi-finished product in a bottom tool member having a non-metal fence for enabling the bottom tool member to support the semi-finished product and the non-metal fence of the bottom tool member to surround the plate member and the shell to keep the plate member and the shell in place, D) moving the bottom tool member vertically to insert the semi-finished product and the fence into the space surrounded by an induction coil of an induction heater; and then pressing a top tool member on the plate member of the semi-finished product, E) operating the induction heater to generate an oscillating current through the induction coil in a predetermined time and at a predetermined power level, thereby heating the border edge of the shell to a temperature level about 20° C.˜100° C. over the melting point of the solder material and causing the solder material to be melted and the gap in between the shell and the plate member to be filled up by the molten solder material, and F) cooling down the solder material to finish the welding procedure.

Preferably, the solder material defines an open frame when it is applied to the surface area of the plate member during step B); the solder material is kept in flush with the outer perimeter of the border edge of the shell, and the width of the strip of solder material is greater than the thickness of the border edge of the shell so that an inner edge of the strip of solder material is kept within the area surrounded by the border edge of the shell.

Preferably, the border edge of the shell has an outer perimeter kept in flush with the periphery of the plate member; the fence is clamped on the outer perimeter of the border edge of the shell and the periphery of the plate member.

Preferably, the strip of solder material defines an open frame when formed during step B); the plate member is larger than the area surrounded by the border edge of the shell, and the strip of solder material has a width greater than the thickness of the border edge of the shell so that the strip of solder material defines an inner edge within the area surrounded by the border edge of the shell and an outer edge beyond the border edge of the shell.

Preferably, the shell is covered on the plate member to form a semi-finished product and then the semi-finished product is placed on the bottom tool member, or alternatively, the shell is placed on the bottom tool member to keep the border edge upwards and then the plate member is covered on the shell.

Preferably, during step D), the bottom tool member is lifted to insert the semi-finished product into the space surrounded by the induction coil.

Preferably, a sub-step of applying a solder flux to the border edge of the shell is employed during Step A) or Step B).

Preferably, during step D), the central height of the induction coil is kept in flush with the elevation of the junction between the shell and the plate member.

Preferably, the predetermined time and the predetermined power level in step E) are obtained by: applying Steps A)˜D) to a reference plate member and a reference shell, and then operating the induction coil subject to a selected power level and using a temperature sensor to detect the temperature of the reference shell, and then measuring the length of time in which the temperature of the reference shell reaches the level about 20° C.˜100° C. over the melting point of the older material.

Preferably, during step D), the induction coil is kept away from the shell and said fence, leaving a gap therebetween.

Preferably, during step F), at least one air source is used to blow air toward the gap between the induction oil and the shell and the fence.

Preferably, the at least one air source is adapted to blow room temperature air toward the gap between the induction oil and the shell and the fence.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic of the present invention, illustrating a shell and a plate member separated.

FIG. 2 is a schematic sectional view of the present invention, illustrating the shell and the plate member attached together.

FIG. 3A is a schematic drawing of the present invention, illustrating the semi-finished product carried on the bottom tool member and spaced below the top tool member.

FIG. 3B corresponds to FIG. 3A, illustrating the bottom tool member lifted and the semi-finished product inserted into the induction coil.

FIG. 3C corresponds to FIG. 3B, illustrating the top tool member pressed on the semi-finished product.

FIG. 4 is a schematic drawing illustrating the space relationship among the bottom tool member, the semi-finished product and the induction coil.

FIG. 5 is a schematic drawing illustrating an air blowing status of two air sources at two opposite sides relative to the induction coil.

FIG. 6 is a schematic drawing illustrating the shell and the plate member welded together.

FIG. 7 is a schematic drawing of an alternate form of the present invention.

### DETAILED DESCRIPTION OF THE INVENTION

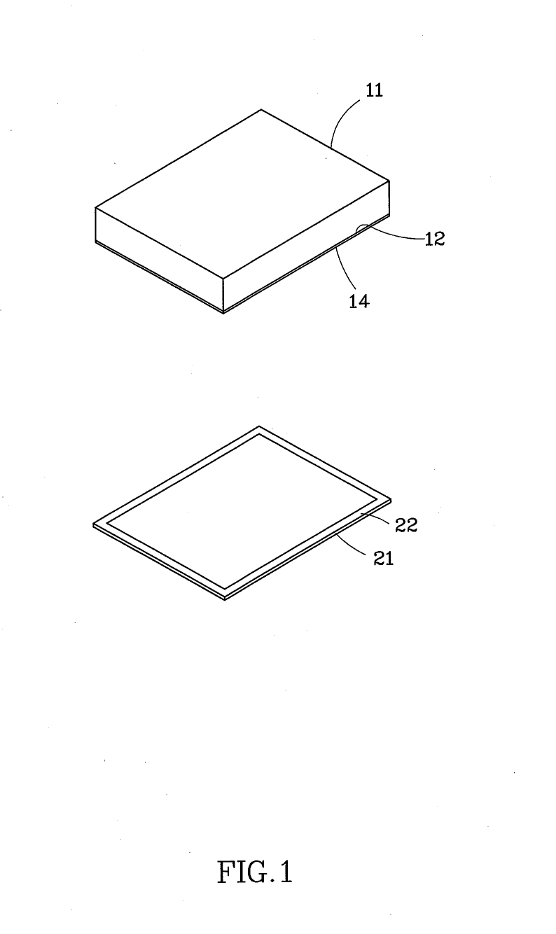

Referring to FIGS. 1-6, a metal shell and plate member welding method in accordance with the present invention comprises the following steps:

A) As illustrated in FIG. 1, prepare a shell 11 and a plate member 21, wherein the shell 11 is a metal member having a border edge 12 for bonding.

B) Apply a strip of solder material 22 to a surface area of the plate member 21 corresponding to the border edge 12 of the shell 11 subject to a predetermined thickness and width. In this embodiment, the applied strip of solder material 22 defines an open frame. However, this open frame configuration is not a limitation.

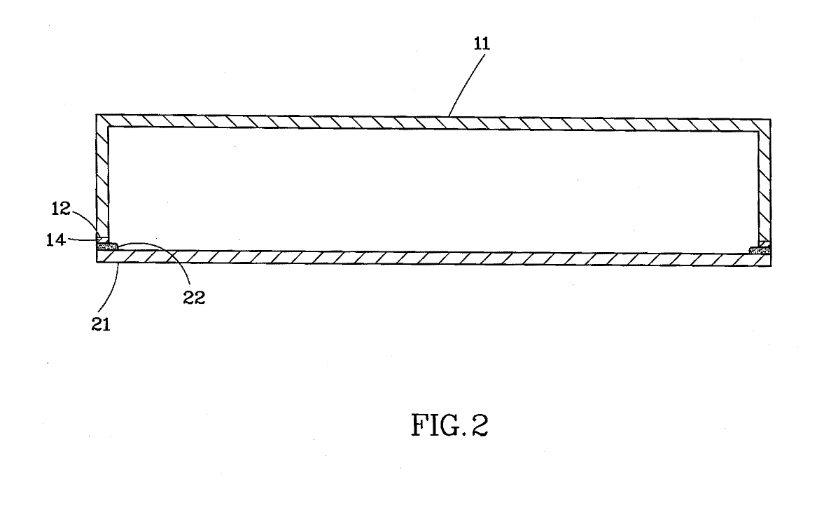

C) As illustrated in FIG. 2, cover the shell 11 on the plate member 21 to attach the border edge 12 of the shell 11 to the applied strip of solder material 22 so that the shell 11, the plate member 21 and the applied strip of solder material 22 form a semi-finished product 29, and then put this semi-finished product 29 in a bottom tool member 31. In actual application, the shell 11 can be covered on the plate member 21 to form a semi-finished product 29, and then the semi-finished product 29 can be placed on the bottom tool member 31. Alternatively, the shell 11 can be placed on the bottom tool member 31 to keep the border edge 12 upward, and then cover the plate member 21 on the shell 11, as shown in FIG. 2. The bottom tool member 31 is adapted to support the semi-finished product 29, having a fence 32 that surrounds the plate member 21 and the shell 11 to keep the plate member 21 and the shell 11 in place. This fence 32 is made of a non-metal material. In this embodiment, the outer perimeter of the border edge 12 of the shell 11 is kept in flush with the periphery of the plate member 21. Further, the fence 32 is slightly clamped on the outer perimeter of the border edge 12 of the shell 11 and the periphery of the plate member 21. Further, the applied strip of solder material 22 is kept in flush with the outer perimeter of the border edge 12 of the shell 11. The width of the applied strip of solder material 22 is greater than the thickness of the border edge 12 of the shell 11. Thus, the inner edge of the applied strip of solder material 22 is kept within the area surrounded by the border edge 12 of the shell 11. Further, enabling the fence 32 to slightly clamp on the outer perimeter of the border edge 12 of the shell 11 and the periphery of the plate member 21 is not requisite. The fence 32 can be configured to surround the shell 11 and the plate member 21 and to keep them in place without clamping on them.

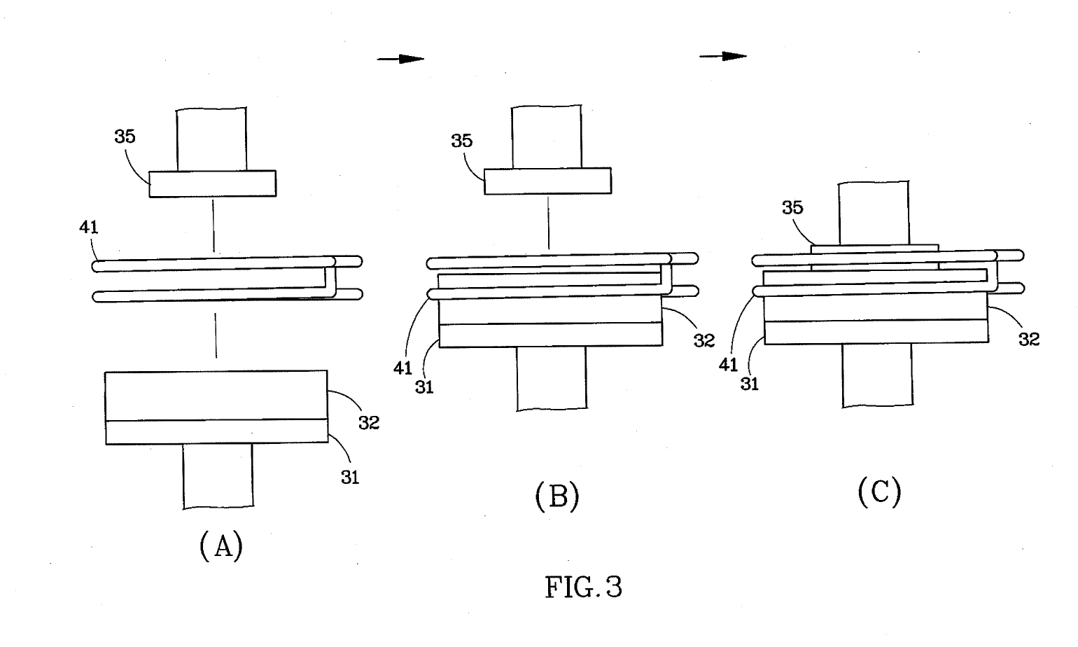

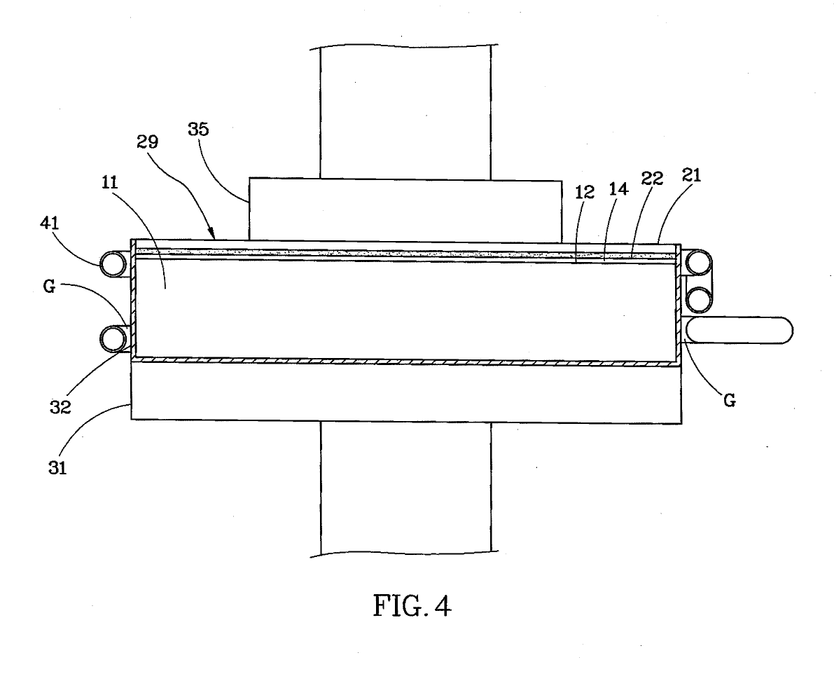

D) As illustrated in FIGS. 3(A) through 3(C), move the bottom tool member 31 up or down to adjust the elevation and to insert the semi-finished product 29 and the fence 32 into the space surrounded by an induction coil 41 of an induction heater. In this embodiment, the central height of the induction coil 41 is kept in flush with the elevation of the junction between the shell 11 and the plate member 21. Thereafter, press a top tool member 35 on the top side of the plate member 21 of the semi-finished product 29. In this embodiment, the bottom tool member 31 is lifted to insert the semi-finished product 29 and the fence 32 upwardly into the space surrounded by the induction coil 41 of the induction heater. Further, as shown in FIG. 4, the induction coil 41 is kept away from the shell 11 and the fence 32, leaving a gap G therebetween. Further, keeping the central height of the induction coil 41 in flush with the elevation of the junction between the shell 11 and the plate member 21 enables the induction coil 41 to achieve optimal heating performance. A minor elevational difference (for example, about 1˜2 mm) between the central height of the induction coil 41 and the elevation of the junction between the shell 11 and the plate member 21 is acceptable. This minor elevational difference can lower the heating performance, but still can achieve the desired heating effect.

E) Operate the induction coil 41 to generate an oscillating current in a predetermined time and at a predetermined power level, so as to heat the border edge 12 of the shell 11 to a temperature level about 20° C.˜100° C. over the melting point of the applied strip of solder material 22, thereby melting the applied strip of solder material 22 and causing the molten solder material to fill up the gap in between the shell 11 and the plate member 21. In this embodiment, the predetermined time and predetermined power level are obtained by: applying the aforesaid steps A)˜D) to a reference plate member 21 and a reference shell 11, and then operate the induction coil 41 subject to a selected power level and using a temperature sensor (not shown) to detect the temperature of the reference shell 11, and then measuring the length of time in which the temperature of the reference shell 11 reaches the level about 20° C.˜100° C. over the melting point of the applied strip of solder material 22. Thus, the predetermined time and predetermined power level are obtained.

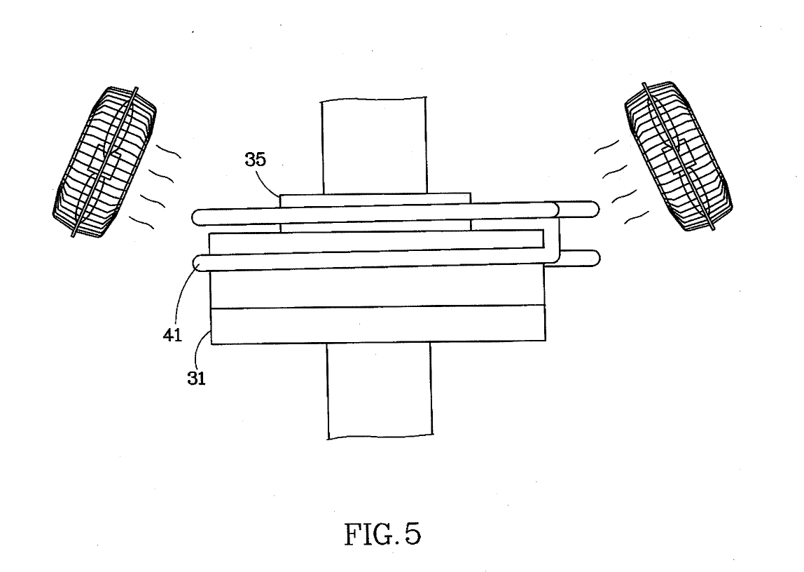

F) After the applied strip of solder material 22 is cooled down and hardened, the welding procedure is down. The product can be cooled down at room temperature. Alternatively, a cooling air source 38 can be applied to the gap G to accelerate cooling. For example, as shown in FIG. 5, two air sources 38 are disposed at two opposite sides relative to the semi-finished product 39 to blow room temperature air, low temperature air toward the gap G. Further, the applied air can be atmospheric gases, or any particular gas, for example, nitrogen. Further, the air sourced 38 can be an electric fan or gas blower.

Further, it is to be noted that during the aforesaid step A) or step B), a solder flux 14 can be applied to the border edge 12 of the shell 11, to smoothen the welding procedure and to achieve a better welding result. However, the use of the solder flux is not requisite.

The aforesaid steps A)˜F) are regarding to welding. After welding, lift or lower the top tool member 35, allowing the finished product to be removed from the bottom tool member 31.

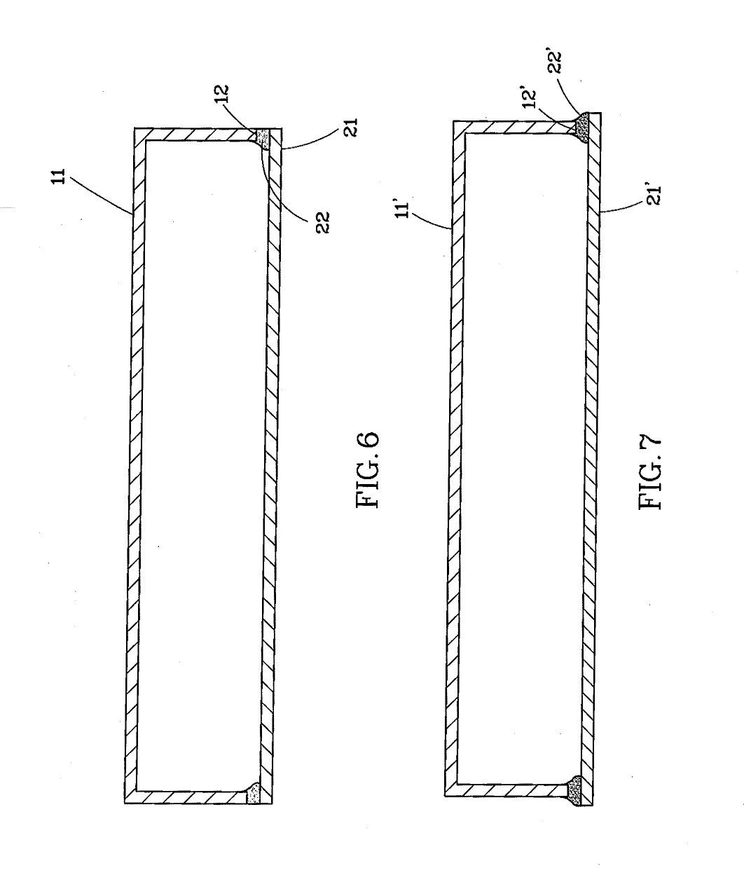

In the aforesaid step E), the applied strip of solder material 22 is disposed in the area surrounded by the border edge 12 of the shell 11. Therefore, when the applied strip of solder material 22 is melted during the heating process, as shown in FIG. 6, the molten solder material 22 will climb the inner wall of the shell 11 to a predetermined height subject to the effect of surface tension, enhancing the welding effect after hardened. However, if the width of the applied strip of solder material 22 is equal to the thickness of the border edge 12 of the shell 11, the solder material 22 will not climb the inner wall of the shell 11 when melted, however, it can still fill up the gap in between the shell 11 and the plate member 21, achieving optimal welding effect.

Further, in the aforesaid embodiment, the periphery of the plate member 21 is kept in flush with the outer perimeter of the shell 11. However, this arrangement is not a limitation. In an alternate form of the present invention, as shown in FIG. 7, the plate member 21′ is slightly larger than the area of border edge 12′ of the shell 11′, and the applied strip of solder material 22′ has a width greater than the thickness of the border edge 12′ of the shell 11′. Thus, the inner edge of the applied strip of solder material 22′ is within the area surrounded by the border edge 12′ of the shell 11′, and the outer edge of the applied strip of solder material 22′ is kept beyond the border edge 12′ of the shell 11′. Thus, when the applied strip of solder material 22′ is melted during the heating process, the molten solder material 22′ will climb the inner and outer walls of the shell 11 to a predetermined height subject to the effect of surface tension, enhancing the welding effect after hardened.

In conclusion, the invention provides a metal shell and plate member welding method that has the advantages as follows:

1. The heating temperature can be controlled, avoiding defective products caused by temperature factors.

2. By means of the bottom tool member, the shell and the plate member can be positively positioned prior to welding, enabling the welding process to be performed steadily and accurately.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A metal shell and plate member welding method, comprising the steps of:
A) preparing a shell and a plate member, said shell being a metal member having a border edge for bonding;
B) applying a solder material to a surface area of said plate member corresponding to said border edge of said shell to form a strip of solder material subject to a predetermined thickness and width;
C) covering said shell on said plate member to attach said border edge of said shell to said solder material and to form a semi-finished product, and then putting said semi-finished product in a bottom tool member having a non-metal fence for enabling said bottom tool member to support said semi-finished product and said non-metal fence of said bottom tool member to surround said plate member and said shell to keep said plate member and said shell in place;
D) moving said bottom tool member vertically to insert said semi-finished product and said fence into the space surrounded by an induction coil of an induction heater; and then pressing a top tool member on said plate member of said semi-finished product;
E) operating said induction heater to generate an oscillating current through said induction coil in a predetermined time and at a predetermined power level, thereby heating said border edge of said shell to a temperature level about 20° C.˜100° C. over the melting point of said solder material and causing said solder material to be melted and the gap in between said shell and said plate member to be filled up by said molten solder material; and
F) cooling down said solder material to finish the welding procedure.

2. The metal shell and plate member welding method as claimed in claim 1, wherein said solder material defines an open frame when said solder material applied to said surface area of said plate member during step B); said solder material is kept in flush with the outer perimeter of said border edge of said shell, and the width of said strip of solder material is greater than the thickness of said border edge of said shell so that an inner edge of said strip of solder material is kept within the area surrounded by said border edge of said shell.

3. The metal shell and plate member welding method as claimed in claim 1, wherein said border edge of said shell has an outer perimeter kept in flush with the periphery of said plate member; said fence is clamped on the outer perimeter of said border edge of said shell and the periphery of said plate member.

4. The metal shell and plate member welding method as claimed in claim 1, wherein said strip of solder material defines an open frame when formed during step B); said plate member is larger than the area surrounded by said border edge of said shell, and said strip of solder material has a width greater than the thickness of said border edge of said shell so that said strip of solder material defines an inner edge within the area surrounded by said border edge of said shell and an outer edge beyond said border edge of said shell.

5. The metal shell and plate member welding method as claimed in claim 1, wherein, during step C), said shell is covered on said plate member to form a semi-finished product and then said semi-finished product is placed on said bottom tool member, or alternatively, said shell is placed on said bottom tool member to keep said border edge upwards and then said plate member is covered on said shell.

6. The metal shell and plate member welding method as claimed in claim 1, wherein during step D), said bottom tool member is lifted to insert said semi-finished product into the space surrounded by said induction coil.

7. The metal shell and plate member welding method as claimed in claim 1, further comprising a sub-step of applying a solder flux to said border edge of said shell during Step A) or Step B).

8. The metal shell and plate member welding method as claimed in claim 1, wherein during step D), the central height of said induction coil is kept in flush with the elevation of the junction between said shell and said plate member.

9. The metal shell and plate member welding method as claimed in claim 1, wherein said predetermined time and said predetermined power level in step E) are obtained by: applying Steps A)˜D) to a reference plate member and a reference shell, and then operating said induction coil subject to a selected power level and using a temperature sensor to detect the temperature of said reference shell, and then measuring the length of time in which the temperature of said reference shell reaches the level about 20° C.˜100° C. over the melting point of said older material.

10. The metal shell and plate member welding method as claimed in claim 1, wherein during step D), said induction coil is kept away from said shell and said fence, leaving a gap therebetween.

11. The metal shell and plate member welding method as claimed in claim 10, wherein during step F), at least one air source is used to blow air toward the gap between said induction oil and said shell and said fence.

12. The metal shell and plate member welding method as claimed in claim 10, wherein said at least one air source is adapted to blow room temperature air toward the gap between said induction oil and said shell and said fence.
